(19) United States
(12) Patent Application Publication
(10) Pub. No.: US 2025/0336226 A1
(43) Pub. Date: Oct. 30, 2025

(54) Scanned Document Detector

(71) Applicant: Astrata, Inc., Pittsburgh, PA (US)

(72) Inventors: Eugene Tseytlin, Pittsburgh, PA (US); Ryan Dickson, Pittsburgh, PA (US); Caleb Dusenbery, Pittsburgh, PA (US)

(21) Appl. No.: 19/178,461

(22) Filed: Apr. 14, 2025

Related U.S. Application Data
(60) Provisional application No. 63/639,064, filed on Apr. 26, 2024.

(51) Int. Cl. G06V 30/416; G06V 30/10

(52) U.S. Cl. CPC G06V 30/416; G06V 30/10

(57) ABSTRACT

Methods, systems, and apparatus, including computer programs encoded on computer storage media, for detecting image document text data. One of the methods includes determining, for an image document that depicts text, whether the image document includes a digital overlay; in response to determining that the image document includes a digital overlay, determining whether the digital overlay comprises text data for the text depicted in the image document, metadata that is a different type of data than the text data, or both; and in response to determining that the digital overlay comprises at least text data: determining to skip optical character recognition of the image document; and providing, to a downstream system, a message that indicates that the image document has text data.

### RELATED APPLICATIONS

This application claims priority to U.S. Provisional Application Ser. 63/639,064, filed on Apr. 26, 2024. The entire contents of which are hereby incorporated in its entirety.

### BACKGROUND

Natural language processing (“NLP”) systems can process documents to detect relationships between words in a single document. For instance, an NLP system can process a document to determine contextual nuances of the language included in the document when such nuances are not explicitly included in the document or the document's metadata.

### SUMMARY

In general, one aspect of the subject matter described in this specification can be embodied in methods that include the actions of determining, for an image document that depicts text, whether the image document includes a digital overlay; in response to determining that the image document includes a digital overlay, determining whether the digital overlay comprises text data for the text depicted in the image document, metadata that is a different type of data than the text data, or both; and in response to determining that the digital overlay comprises at least text data: determining to skip optical character recognition of the image document; and providing, to a downstream system, a message that indicates that the image document has text data.

In general, one aspect of the subject matter described in this specification can be embodied in methods that include the actions of determining, for an image document that depicts text, whether the image document includes a digital overlay; in response to determining that the image document includes a digital overlay, determining whether the digital overlay comprises text data for the text depicted in the image document, metadata that is a different type of data than the text data, or both; and in response to determining that the digital overlay comprises only metadata data: determining that optical character recognition of the image document should be performed; and providing a request for optical character recognition of the image document.

In general, one aspect of the subject matter described in this specification can be embodied in methods that include the actions of determining, for an image document that depicts text, whether the image document includes a digital overlay that can comprise text data for the text depicted in the image document, metadata that is a different type of data than the text data, or both and further analysis is required to determine whether to perform optical character recognition of the image document; and in response to determining that the image document does not include a digital overlay: determining that optical character recognition of the image document should be performed; and providing a request for optical character recognition of the image document.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, providing the message can include providing data for the image document and the text data.

In some implementations, determining whether the digital overlay includes metadata can include determining whether the digital overlay includes metadata for one or more of text that is not depicted in the image document, or for text that is depicted in the image document and satisfies a text quantity threshold.

In some implementations, determining whether the digital overlay includes metadata can include: determining one or more locations for data included in the digital overlay; determining, for each of the one or more locations, whether the corresponding location satisfies one or more metadata position conditions; and in response to determining that each of the one or more locations satisfy the one or more metadata conditions, determining that the digital overlay includes metadata. The one or more metadata position conditions can include one or more of a header position condition or one or more footer position conditions.

In some implementations, determining whether the digital overlay includes text data can include determining whether the digital overlay comprises text data for all text depicted in the image document, or for a quantity of text depicted in the image document that does not satisfy a text quantity threshold.

In some implementations, the method can include predicting a number of lines of text in a page of the image document. Determining whether the digital overlay includes text data for the text depicted in the image document, metadata that is a different type of data than the text data, or both can use the number of predicted lines of text in the page of the image document.

In some implementations, the method can include detect a number of pages in the image document. Determining whether the digital overlay comprises text data for the text depicted in the image document, metadata that is a different type of data than the text data, or both can use the number of pages in the image document.

In some implementations, the method can include predicting whether the image document includes an image that represents a page. Determining whether the digital overlay comprises text data for the text depicted in the image document, metadata that is a different type of data than the text data, or both can use a result of predicting whether the image document includes an image that represents a page.

In some implementations, determining whether the digital overlay comprises text data, metadata, or both can include: determining whether the image document includes a cover page that defines the image document; and determining whether the digital overlay comprises text data for the text depicted in the image document, metadata that is a different type of data than the text data, or both using a result of whether the image document includes a cover page.

In some implementations, determining whether the digital overlay includes text data, metadata, or both can include: determining that the image document includes the cover page that defines the image document; and in response to determining that the image document includes the cover page that defines the image document, determining that the digital overlay includes metadata.

In some implementations, determining whether the digital overlay comprises text data, metadata, or both can include: determining that the image document does not include a cover page that defines the image document; and in response to determining that the image document does not include a cover page that defines the image document, determining that the digital overlay comprises text data.

In some implementations, providing the message to the downstream system can include providing, to a natural language processing system, the message that indicates that the image document has text data.

In some implementations, determining whether the digital overlay comprises text data, metadata, or both can include: determining that the image document includes a cover page that defines the image document; and in response to determining that the image document includes the cover page that defines the image document, determining that the digital overlay includes metadata.

In some implementations, the method can include: determining that the digital overlay only includes one or more of header data or footer data for any pages in the image document other than the cover page. Determining that the digital overlay only includes metadata can be responsive to determining that the digital overlay only includes one or more of header data or footer data for any pages in the image document other than the cover page.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, the systems and methods described in this specification can result in more accurate optical character recognition (“OCR”) compared to other systems, e.g., when a received image document includes text data and any secondary OCR might be less accurate or degrade text quality, or when a received document includes only metadata and OCR should be performed to generate text data. In some implementations, the systems and methods described in this specification can use fewer computational resources, e.g., upon determining to skip performing OCR for a document that already includes text data. The computational resources can include time, processor cycles, memory, or other appropriate computational resources. In some implementations, the systems and methods described in this specification can result in improved data security, e.g., by not sending an image document to an external system for OCR when there is already text data for the image document and the transmission to the external system might introduce security risk. In some implementations, the systems and methods described in this specification can reduce computational resource usage, e.g., by determining to skip performing OCR for an image document that already has text data.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which a system analyzes an image document for optical character recognition.

FIG. 2 is a flow diagram of an example process for determining whether an image document has text data.

FIG. 3 is a block diagram of a computing system that can be used in connection with computer-implemented methods described in this specification.

Like reference numbers and designations in the various drawings indicate like elements.

### DETAILED DESCRIPTION

Some systems perform optical character recognition (“OCR”) on scanned documents. However, when an image document already includes text data, the OCR process would be unnecessary, potentially introduce errors, potentially less accurate, or a combination of these. An example of an image document includes a portable document file (“PDF”), though other types of image documents that can include corresponding text data are also considered.

A system can determine whether an image document includes text data, e.g., for natural language processing, by determining whether the image document includes a digital overlay that contains text data. A digital overlay can include data that is superimposed on top of an image for the image document, e.g., a header stamped on each page of the image document, or OCR data, to name a few examples. In this specification, text data is different from metadata in that the text data includes data for the actual characters in the underlying image document while metadata does not. For instance, metadata might include a document creation date, a name for a document creator or an entity described in the document, or a combination of these, but does not include the data for the actual characters, e.g., at least a threshold quantity of characters, in the underlying image document. As a result, the metadata alone would be insufficient for any processing of the document because the metadata is incomplete.

Upon determining that the image document includes a digital overlay, the system can determine whether the digital overlay includes text data. If the determination is positive, the system can determine to skip performing OCR for the image document. If either of the determinations is negative, the system can perform OCR for the image document.

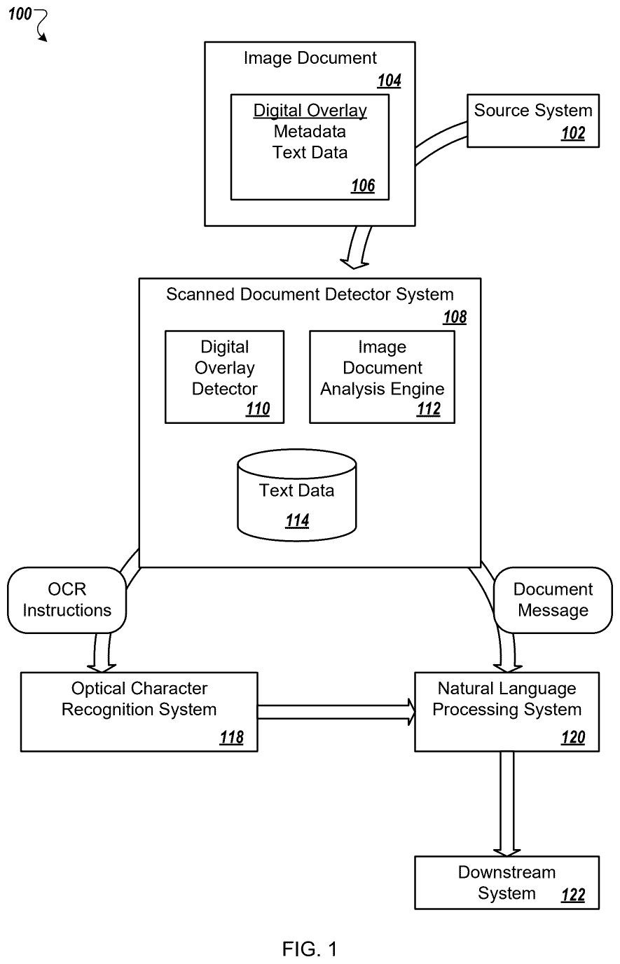

FIG. 1 depicts an example environment 100 in which a system analyzes an image document for optical character recognition. A source system 102 can provide the image document 104 to a scanned document detector system 108. The scanned document detector system 108 can perform one or more operations to determine whether optical character recognition should be performed on the image document 104. This can occur as part of a natural language processing (“NLP”) process for the image document 104 such that a natural language processing system 120 would be unable to process the image document 104 if the image document 104 does not have text data for the text depicted in the image document 104.

For instance, the natural language processing system 120 can process a variety of different types of documents. Some of the documents might not include any data for a digital overlay 106. Some of the documents can include text data for the corresponding text depicted in the image document 104. The text data can be a type of data included in a digital overlay 106 for an image document 104. Another type of data for a digital overlay 106 can include metadata. Metadata is data that does not necessarily represent the text depicted in the image document 104 and instead includes other types of data or only a small subset of data for the text depicted in the image document. The small subset of data has a size that is insufficient for accurate NLP processing of the image document 104 by the natural language processing system 120.

In some examples, although metadata might include a person's name, which name is depicted in the image document 104, the metadata would not include data for all the rest of the text depicted in the image document 104. For example, the metadata can include a document creation date, a name for a document creator, a name of another entity, e.g., in addition to or instead of the person's name, or a combination of these. However, if the document describes various details about the person or notes taken by the person, the metadata would not necessarily include digital data that represents these details or notes.

Given the different types of documents, that can include various combinations of metadata, text data, or just the underlying image document 104, the environment 100 should not treat all of the various document types in the same manner. For instance, the optical character recognition system 118 might generate inadvertent errors during an OCR process. If the underlying image document 104 already has text data, these errors can make any NLP processes less accurate, e.g., compared to NLP processes using the existing text data.

The scanned document detector system 108 can determine whether an image document 104 should be processed by the optical character recognition system 118. This can reduce a risk of errors; reduce computational resource usage, e.g., required by an unnecessary OCR process; increase an accuracy of text data for an image document 104; increase a likelihood that different entities use the same text data for the image document 104, e.g., the source system and the natural language processing system 120; reduce a potential failure point, e.g., a potential data security failure point that might exist by sending the image document 104 to the optical character recognition system 118; or a combination of two or more of these.

The scanned document detector system 108 can use a digital overlay detector 110 to determine whether the image document 104 includes a digital overlay 106. The digital overlay detector 110 can detect a digital overlay using any appropriate process. For instance, the digital overlay detector 110 can determine whether the image document 104 only includes one or more images, e.g., and does not include other data, or whether the image document 104 includes other data, e.g., other than data for a file that contains the image document 104. The other data can be any appropriate type of metadata or text data.

When the digital overlay detector 110 determines that the image document 104 does not include a digital overlay 106, the scanned document detector system 108 can send OCR instructions to the optical character recognition system 118. The OCR instructions can be included in one or more messages along with data for the image document 104. In some examples, the OCR instructions can identify a location at which the image document 104 is stored and cause the optical character recognition system 118 to retrieve the image document 104 from the storage, e.g., a database.

Receipt of the OCR instructions cause the optical character recognition system 118 to perform an OCR process on the image document 104. The optical character recognition system 118 can perform any appropriate type of OCR process, e.g., given the image document 104.

When the digital overlay detector 110 determines that the image document 104 includes a digital overlay 106, an image document analysis engine 112 can determine whether the digital overlay 106 includes text data for the image document. For instance, the digital overlay detector 110 can provide a message to the image document analysis engine 112 that indicates that the image document 104 includes the digital overlay 106.

Since the digital overlay 106 might include metadata instead of or in addition to text data, the scanned document detector system 108 should not stop further analysis of the image document 104 given detection of the digital overlay 106 itself. If the scanned document detector system 108 were to stop, but the digital overlay 106 only includes metadata, any data provided to the natural language processing system 120 would be incomplete since the metadata does not include the text data for the image document 104.

The image document analysis engine 112 uses data for the digital overlay 106 to determine whether the digital overlay 106 includes text data. In some examples, the image document analysis engine 112 can determine whether the digital overlay 106 includes metadata. These determinations can be performed in parallel. For instance, when the digital overlay can include only either text data or metadata, or both, and the image document analysis engine 112 determines whether the digital overlay 106 includes text data, this determination can inherently be a determination whether the digital overlay 106 includes metadata.

The image document analysis engine 112 can determine whether the digital overlay includes text data using any appropriate process. Since the image document 104 docs not necessarily include OCR data, e.g., text data, the image document analysis engine 112 cannot use the content of the document, as represented by text data, to determine whether the digital overlay includes text data. As a result, the image document analysis engine 112 can use one or more metadata conditions to determine whether the digital overlay includes text data.

The one or more metadata conditions can indicate one or more likely metadata locations in documents, one or more text quantity thresholds, one or more cover page conditions, or a combination of these. The one or more likely metadata locations can include one or more header locations, one or more footer locations, or a combination of both. The one or more cover page conditions can indicate properties of a cover page, e.g., a page location in the image document 104 such as the first page, a maximum text quantity threshold, or both. The one or more text quantity thresholds can indicate a number of words, a number of lines, or a combination of both, that indicates that the digital overlay likely includes data other than metadata, e.g., includes text data.

The image document analysis engine 112 can determine whether any of the one or more metadata conditions are satisfied. When the image document analysis engine 112 determines that one or more of the metadata conditions are satisfied, the image document analysis engine 112 can determine that the image document 104 likely includes metadata. When the image document analysis engine 112 determines that one or more of the metadata conditions are not satisfied, the image document analysis engine can determine that the image document likely includes text data. This latter determination might not include an affirmative determination that the digital overlay does not include metadata, e.g., but rather than the digital overlay 106 includes at least text data.

For instance, when a maximum text quantity threshold is not satisfied, e.g., and the image document 104 includes more than the maximum text quantity of words, the image document analysis engine 112 can determine that the digital overlay 106 likely includes text data. The text quantity threshold can be for the entire image document 104; any single page in the image document 104; a particular page in the image document 104, e.g., the first page; a subset of pages in the image document 104, e.g., all pages other than the first page; or a combination of two or more of these.

The image document analysis engine 112 can determine that the image document 104 likely includes a cover page upon detecting that at least some of the one or more cover page conditions are satisfied. In response, the image document analysis engine 112 can identify the metadata from the cover page. The image document analysis engine 112 can determine to discard, e.g., delete, the metadata for the cover page.

The image document analysis engine 112 can determine whether at least one of the one or more metadata location conditions are satisfied. The one or more metadata location conditions can indicate likely locations of metadata in image documents 104, such as header locations, footer locations, or a combination of both. In some examples, the image document analysis engine 112 can determine that some of the one or more metadata location conditions are satisfied for a subset of pages in the image document, e.g., each page other than the cover page.

The one or more metadata location conditions can indicate locations in image documents that generally include metadata. These locations can be predetermined, e.g., given input, machine learning, or a combination of both. The one or more metadata location conditions can identify header locations, footer locations, or a combination of both. The image document analysis engine 112 can determine whether any of the one or more metadata location conditions are satisfied, e.g., that the image document 104 likely includes metadata in the digital overlay at any of the metadata locations. If so, the image document analysis engine 112 can determine to discard, e.g., delete, any metadata included in the determined metadata locations.

When the image document analysis engine 112 determines that some of the one or more metadata conditions are not satisfied, e.g., the one or more text quantity thresholds, the image document analysis engine 112 can determine that the digital overlay 106 likely includes text data. In some examples, when the image document analysis engine 112 determines that a threshold quantity of the one or more metadata conditions are not satisfied, that particular ones of the one or more metadata conditions are not satisfied, or a combination of both, the image document analysis engine 112 can determine that the digital overlay 106 likely includes text. For instance, in response to determining that the one or more metadata location conditions and the one or more cover page conditions are not satisfied, the image document analysis engine 112 can determine that the digital overlay 106 likely includes text data.

The image document analysis engine 112, or another component of the scanned document detector system 108, can extract any detected text data from the digital overlay 106. The scanned document detector system 108 can store the extracted text data 114 in memory, provide the extracted text data 114 to the natural language processing system 120, e.g., as part of a document message, or a combination of both. For instance, the scanned document detector system 108 can provide the document message to the natural language processing system 120 that causes the natural language processing system 120 to perform an NLP process on the text data.

The natural language processing system 120 can provide natural language processing data to one or more downstream systems 122. The downstream systems 122 can perform analysis of the natural language processing data, e.g., that might be more accurate than such analysis would be otherwise if the optical character recognition system 118 processed the data, that might be received more quickly given the saved computational resources, or a combination of both.

In some implementations, the scanned document detector system 108 can use a page count for the image document 104; an image count, e.g., that represents a page in the image document 104 in contrast to a schema that includes data for the page; a first page line count for the first page in the image document 104; an average line count for pages subsequent to the first page in the image document; or a combination of two or more of these. The image document analysis engine 112 can determine the page count, the image count, the first page line count, or the average line count using any appropriate process. The image document analysis engine 112 can determine the page count, the image count, the first page line count, the average line count, or a combination of these using the digital overlay, e.g., when the digital overlay 106 includes an identifier that indicates a page to which data in the digital overlay 106 corresponds.

In some examples, the image document analysis engine 112 can determine whether the image document 104 includes images that represent the pages of the image document or text data, e.g., in a schema such as XML. In some implementations, the image document analysis engine 112 can determine that the image count is zero and the first page line count is greater than two. In these implementations, the image document analysis engine 112 can determine that the digital overlay 106 includes at least text data. This can indicate that the image document 104 does not include any scanned images and instead includes structured text data, e.g., in a schema. If the image document analysis engine 112 determined that the first page line count is less than two, the image document analysis engine 112 might determine that the digital overlay 106 includes only metadata.

In some implementations, the image document analysis engine 112 can determine that the page count is greater than two and the average line count for pages subsequent to the first page is less than six. In these implementations, the image document analysis engine 112 can determine that the digital overlay 106 includes only metadata, e.g., and does not include text data. This analysis can determine whether the one or more metadata location conditions are satisfied, e.g., whether there is header, footer, or both, metadata.

In some implementations, the image document analysis engine 112 can determine that the first page line count is less than fifteen. In these implementations, the image document analysis engine 112 can determine that the digital overlay 106 does not include text data.

In some implementations, when the image document analysis engine 112 determines that all of the conditions described in the above three paragraphs are not satisfied, the image document analysis engine 112 can determine that the digital overlay 106 includes text data.

The systems 102, 108, 118, 120, and 122 are examples of systems implemented as computer programs on one or more computers in one or more locations, in which the systems, components, and techniques described in this specification are implemented. A network (not shown), such as a local area network (“LAN”), wide area network (“WAN”), the Internet, or a combination thereof, connects the systems 102, 108, 118, 120, and 122. The systems 102, 108, 118, 120, and 122 can use a single computer or multiple computers operating in conjunction with one another, including, for example, a set of remote computers deployed as a cloud computing service.

The systems 102, 108, 118, 120, and 122 can include several different functional components, including the digital overlay detector 110 and the image document analysis engine 112. The digital overlay detector 110, the image document analysis engine 112, or a combination of these, can include one or more data processing apparatuses, can be implemented in code, or a combination of both. For instance, each of the digital overlay detector 110 and the image document analysis engine 112 can include one or more data processors and instructions that cause the one or more data processors to perform the operations discussed herein.

The various functional components of one or more of the systems 102, 108, 118, 120, or 122 can be installed on one or more computers as separate functional components or as different modules of a same functional component. For example, the components of any of the systems can be implemented as computer programs installed on one or more computers in one or more locations that are coupled to each through a network. In cloud-based systems for example, these components can be implemented by individual computing nodes of a distributed computing system.

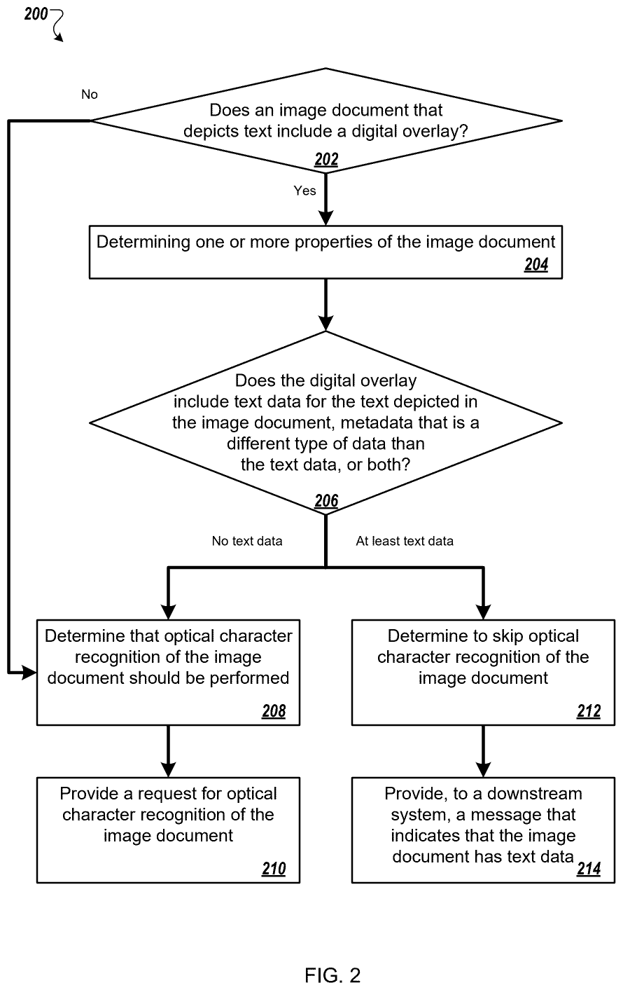

FIG. 2 is a flow diagram of an example process 200 for determining whether an image document has text data. For example, the process 200 can be used by the scanned document detector system 108 from the environment 100.

A scanned document detector system determines whether an image document that depicts text includes a digital overlay (202). For instance, the scanned document detector system analyzes data for the image document to determine whether the image document includes a digital overlay. In some examples, the image document might not include any actual images, e.g., when a PDF document includes only structured text data for the document. In these implementations, the scanned document detector system determines that the document includes a digital overlay.

The scanned document detector system determines one or more properties of the image document (204). For instance, the scanned document detector system can determine a page count, an image count, one or more line counts for one or more pages, or a combination of two or more of these. A line count can include an average line count.

The scanned document detector system determines whether the digital overlay includes text data for the text depicted in the image document, metadata that is a different type of data than the text data, or both (206). The scanned document detector system can perform this operation whether the image document includes one or more images or not. The scanned document detector system can use any appropriate process to perform this operation, such as the processes described in more detail elsewhere in this specification.

The scanned document detector system determines that optical character recognition of the image document should be performed (208). For instance, in response to determining that the image document does not include a digital overlay, or in response to determining that the digital overlay does not include any text data, e.g., includes only metadata, the scanned document detector system can determine that optical character recognition of the image document should be performed.

The scanned document detector system provides a request for optical character recognition of the image document (210). The scanned document detector system can provide the request to an optical character recognition system. The optical character recognition system can be a separate system, e.g., a cloud computing system separate from the one or more systems that implement the scanned document detector system. Provision of the request to the optical character recognition system can cause the optical character recognition system to perform one or more OCR processes on the image document to generate text data for the document. The optical character recognition system can provide the text data to one or more downstream systems for further processing. For instance, the optical character recognition system can provide the text data to a natural language processing system that can make one or more inferences given the text data. Provision of the request can improve downstream processing of the image document, e.g., by generating text data that would otherwise be unavailable.

The scanned document detector system determines to skip optical character recognition of the image document (212). For example, in response to determining that the digital overlay includes text data, the scanned document detector system can determine to skip optical character recognition of the image document. This can reduce computational resource usage.

The scanned document detector system provides, to a downstream system, a message that indicates that the image document has text data (214). The downstream system can be any appropriate system, e.g., a natural language processing system or another system. The message can include the text data, identify a location, e.g., in a database, at which the downstream system can access the text data, or a combination of both.

The order of operations in the process 200 described above is illustrative only, and determining whether the image document has text data can be performed in different orders. For example, the scanned document detector can determine the one or more properties of the image document and then determine whether the image document includes the digital overlay. In some implementations, the process 200 can perform these operations or other pairs of operations at least partially concurrently. The process 200 can include operation 210 before operation 208, e.g., and with the same trigger as operation 208. The process 200 can include operation 214 before operation 212, e.g., and with the same trigger as operation 212.

In some implementations, the process 200 can include additional operations, fewer operations, or some of the operations can be divided into multiple operations. For example, the process 200 need not include operation 204. In some implementations, the process 200 might not include operations 208, 210, or both. In some examples, the process 200 might not include operations 212, 214, or both. The process 200 can include operation 202 and one or both of operations 208 or 210, e.g., without the other operations.

In some implementations, the process 200 can include other types of input to determine whether to perform or skip performing optical character recognition. For instance, the process 200 can include providing data for an image document to a classifier, e.g., an artificial intelligence classifier, that generates output indicating whether data for the image document should be provided to an OCR process.

In this specification, the term “database” is used broadly to refer to any collection of data: the data does not need to be structured in any particular way, or structured at all, and it can be stored on storage devices in one or more locations. A database can be implemented on any appropriate type of memory.

An electronic document, which for brevity will simply be referred to as a document, may, but need not, correspond to a file. A document may be stored in a portion of a file that holds other documents, in a single file dedicated to the document in question, or in multiple coordinated files.

In this specification the term “engine”, of which a detector is one type, is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

Operations can occur substantially concurrently in that the operations need not be exactly concurrent but can overlap at least in part. For instance, a first operation can begin and sometime after that a second operation can begin while the first operation is still occurring. Execution of the two operations, whether by the same system or different systems, can be substantially concurrently. In some examples, two operations can execute substantially concurrently when they have the same start time, same end time, or both.

In this specification, the term likely can mean that there is a likelihood that something might occur and that the likelihood satisfies a likelihood threshold. For instance, when determining that a location is a likely metadata location, a system would determine a likelihood that the location has metadata. The system would then determine whether the likelihood satisfies, e.g., is greater than or equal to, a likelihood threshold by comparing the two values. If so, the system determines that the location is a likely location. If not, the system determines that the location is not a likely location for the metadata.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

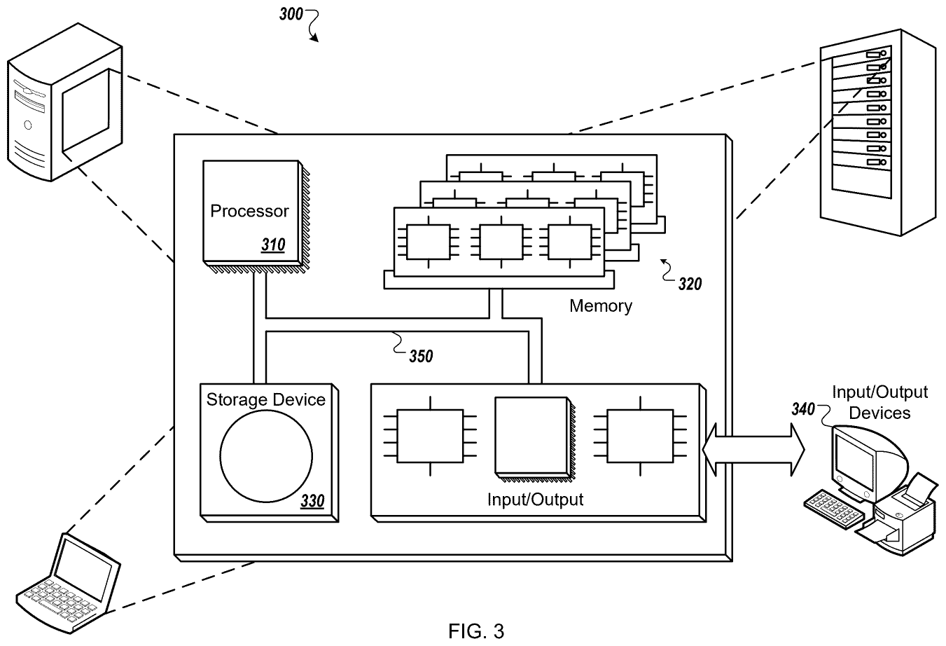

An example of one such type of computer is shown in FIG. 3, which shows a schematic diagram of a computer system 300. The computer system 300 can be used for the operations described in association with any of the computer-implemented methods described previously, according to some implementations. The computer system 300 includes a processor 310, a memory 320, a storage device 330, and an input/output device 340. Each of the components 310, 320, 330, and 340 are interconnected using a system bus 350. The processor 310 is capable of processing instructions for execution within the computer system 300. In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output device 340.

The memory 320 stores information within the computer system 300. In some implementations, the memory 320 is a computer-readable medium. In some implementations, the memory 320 is a volatile memory unit. In some implementations, the memory 320 is a non-volatile memory unit.

The storage device 330 is capable of providing mass storage for the computer system 300. In some implementations, the storage device 330 is a computer-readable medium. In some implementations, the storage device 330 can be a floppy disk device, a hard disk device, an optical disk device, or a tape device.

The input/output device 340 provides input/output operations for the computer system 300. In some implementations, the input/output device 340 includes a keyboard, a pointing device, a touchscreen, or a combination of these. In some implementations, the input/output device 340 includes a display unit for displaying graphical user interfaces. In some implementations, the input/output device 340 includes a microphone, a speaker, or a combination of both.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

What is claimed is:

1. A computer-implemented method comprising:
determining, for an image document that depicts text, whether the image document includes a digital overlay;
in response to determining that the image document includes a digital overlay, determining whether the digital overlay comprises text data for the text depicted in the image document, metadata that is a different type of data than the text data, or both; and
in response to determining that the digital overlay comprises at least text data:
determining to skip optical character recognition of the image document; and
providing, to a downstream system, a message that indicates that the image document has text data.

2. The method of claim 1, wherein providing the message comprises providing data for the image document and the text data.

3. The method of claim 1, wherein determining whether the digital overlay comprises metadata comprises determining whether the digital overlay comprises metadata for one or more of text that is not depicted in the image document, or for text that is depicted in the image document and satisfies a text quantity threshold.

4. The method of claim 1, wherein determining whether the digital overlay comprises metadata comprises:
determining one or more locations for data included in the digital overlay;
determining, for each of the one or more locations, whether the corresponding location satisfies one or more metadata position conditions; and
in response to determining that each of the one or more locations satisfy the one or more metadata conditions, determining that the digital overlay comprises metadata.

5. The method of claim 4, wherein the one or more metadata position conditions comprise one or more of a header position condition or one or more footer position conditions.

6. The method of claim 1, wherein determining whether the digital overlay comprises text data comprises determining whether the digital overlay comprises text data for all text depicted in the image document, or for a quantity of text depicted in the image document that does not satisfy a text quantity threshold.

7. The method of claim 1, comprising:
predicting a number of lines of text in a page of the image document, wherein determining whether the digital overlay comprises text data for the text depicted in the image document, metadata that is a different type of data than the text data, or both uses the number of predicted lines of text in the page of the image document.

8. The method of claim 1, comprising:
detect a number of pages in the image document, wherein determining whether the digital overlay comprises text data for the text depicted in the image document, metadata that is a different type of data than the text data, or both uses the number of pages in the image document.

9. The method of claim 1, comprising:
predicting whether the image document includes an image that represents a page, wherein determining whether the digital overlay comprises text data for the text depicted in the image document, metadata that is a different type of data than the text data, or both uses a result of predicting whether the image document includes an image that represents a page.

10. The method of claim 1, wherein determining whether the digital overlay comprises text data, metadata, or both comprises:
determining whether the image document includes a cover page that defines the image document; and
determining whether the digital overlay comprises text data for the text depicted in the image document, metadata that is a different type of data than the text data, or both using a result of whether the image document includes a cover page.

11. The method of claim 10, wherein determining whether the digital overlay comprises text data, metadata, or both comprises:
determining that the image document includes the cover page that defines the image document; and
in response to determining that the image document includes the cover page that defines the image document, determining that the digital overlay comprises metadata.

12. The method of claim 10, wherein determining whether the digital overlay comprises text data, metadata, or both comprises:
determining that the image document does not include a cover page that defines the image document; and
in response to determining that the image document does not include a cover page that defines the image document, determining that the digital overlay comprises text data.

13. The method of claim 1, wherein providing the message to the downstream system comprises providing, to a natural language processing system, the message that indicates that the image document has text data.

14. A system comprising one or more computers and one or more storage devices on which are stored instructions that are operable, when executed by the one or more computers, to cause the one or more computers to perform operations comprising:
determining, for an image document that depicts text, whether the image document includes a digital overlay;
in response to determining that the image document includes a digital overlay, determining whether the digital overlay comprises text data for the text depicted in the image document, metadata that is a different type of data than the text data, or both; and
in response to determining that the digital overlay comprises only metadata data:
determining that optical character recognition of the image document should be performed; and
providing a request for optical character recognition of the image document.

15. The system of claim 14, wherein determining whether the digital overlay comprises text data, metadata, or both comprises:
determining that the image document includes a cover page that defines the image document; and
in response to determining that the image document includes the cover page that defines the image document, determining that the digital overlay comprises metadata.

16. The system of claim 15, the operations comprising:
determining that the digital overlay only includes one or more of header data or footer data for any pages in the image document other than the cover page,
wherein determining that the digital overlay only includes metadata is responsive to determining that the digital overlay only includes one or more of header data or footer data for any pages in the image document other than the cover page.

17. One or more computer storage media encoded with instructions that, when executed by one or more computers, cause the one or more computers to perform operations comprising:
determining, for an image document that depicts text, whether the image document includes a digital overlay that can comprise text data for the text depicted in the image document, metadata that is a different type of data than the text data, or both and further analysis is required to determine whether to perform optical character recognition of the image document; and
in response to determining that the image document does not include a digital overlay:
determining that optical character recognition of the image document should be performed; and
providing a request for optical character recognition of the image document.

18. The media of claim 17, wherein providing the message comprises providing data for the image document and the text data.

19. The media of claim 17, wherein determining whether the digital overlay comprises metadata comprises determining whether the digital overlay comprises metadata for one or more of text that is not depicted in the image document, or for text that is depicted in the image document and satisfies a text quantity threshold.

20. The media of claim 17, wherein determining whether the digital overlay comprises metadata comprises:
determining one or more locations for data included in the digital overlay;
determining, for each of the one or more locations, whether the corresponding location satisfies one or more metadata position conditions; and
in response to determining that each of the one or more locations satisfy the one or more metadata conditions, determining that the digital overlay comprises metadata.
